(19) United States
(12) Patent Application Publication
(10) Pub. No.: US 2012/0183001 A1
(43) Pub. Date: Jul. 19, 2012

(54) Network apparatus, network configuration method and program recording medium which records a network apparatus program

(75) Inventors: Jun Suzuki, Tokyo (JP); Teruyuki Baba, Tokyo (JP); Satoshi Uchida, Tokyo (JP); Takashi Yoshikawa, Tokyo (JP)

(73) Assignee: NEC CORPORATION, Tokyo (JP)

(21) Appl. No.: 13/137,614

(22) Filed: Aug. 30, 2011

Related U.S. Application Data
(63) Continuation of application No. PCT/JP2011/051030, filed on Jan. 14, 2011.

(51) Int. Cl. H04L 12/56

(52) U.S. Cl. 370/419

(57) ABSTRACT

A network apparatus includes a first interface unit which connects a host which holds a plurality of I/O buses and an own network apparatus via a network, a second interface unit which connects a peripheral device which holds a plurality of I/O interfaces and an own network apparatus, a control unit which controls the plurality of I/O interfaces to be connected to branches of the different I/O buses respectively.

This application is based upon and claims the benefit of priority from PCT patent application No. PCT/JP2011/051030, filed on Jan. 14, 2011, the disclosure of which is incorporated herein in its entirety by reference.

### TECHNICAL FIELD

The present invention relates to a network apparatus, a network configuration method and a program recording medium which records a network apparatus program that enables a flexible bus connection between a host and a peripheral device in particular.

### BACKGROUND ART

FIG. 17 shows an example of a network system related to the present invention disclosed in patent document 1. A network system shown in FIG. 17 includes host 1, Ethernet (®) switch 200, downstream PCI (Peripheral Component Interconnect) Express-Ethernet bridge 7 and peripheral device 8.

The downstream PCI Express-Ethernet bridge 7 bridges between the PCI Express bus and the Ethernet switch 200. Further, the PCI Express bus is the specification name of the I/O bus standardized by PCI-SIG (PCI Special Interest Group).

The host 1 includes a CPU (Central Processing Unit) 11, a memory 13, a route complex 121 and an upstream PCI Express-Ethernet bridge 15. The route complex 121 connects the CPU 11, the memory 13 and the upstream PCI Express-Ethernet bridge 15 mutually. The upstream PCI Express-Ethernet bridge 15 is the network interface which bridges between the PCI Express bus and the Ethernet switch 200. The packet sent and received between the CPU 11 or the memory 13 and peripheral device 8 is called an I/O packet.

When the I/O packet is received from the route complex 121, the upstream PCI Express-Ethernet bridge 15 encapsulates the received I/O packet with Ethernet frame whose destination is the downstream PCI Express-Ethernet bridge 7 and transmits it to Ethernet switch 200.

When receiving the Ethernet frame that is the encapsulated I/O packet from Ethernet switch 200, the upstream PCI Express-Ethernet bridge 15 encapsulates the received I/O packet and transmits it to the route complex 121.

When the downstream PCI Express-Ethernet bridge 7 receives an Ethernet frame that an I/O packet is encapsulated from Ethernet switch 200, the downstream PCI Express-Ethernet bridge 7 decapsulates the received I/O packet and transmits it to peripheral device 8.

The downstream PCI Express-Ethernet bridge 7 receives an I/O packet from the peripheral device 8. And then, the downstream PCI Express-Ethernet bridge 7 encapsulates the received I/O packet with Ethernet frame whose destination is the upstream PCI Express-Ethernet bridge 15 and transmits it to the Ethernet switch 200.

The network system indicated in FIG. 17 operates as follows.

When the CPU 11 issues an I/O packet by the software control, the I/O packet is transmitted to the upstream PCI Express-Ethernet bridge 15 via the route complex 121. The upstream PCI Express Ethernet bridge 15 encapsulates the received I/O packet using Ethernet frame and transmits it to the Ethernet switch 200 in which the upstream PCI Express-Ethernet bridge 7 is set as the destination. The downstream PCI Express-Ethernet bridge 7 receives the Ethernet frame which encapsulates an I/O packet, decapsulates the I/O packet and transmits it to peripheral device 8.

On the other hand, when the peripheral device 8 issues an I/O packet, the downstream PCI Express-Ethernet bridge 7 encapsulates the I/O packet received from the peripheral device 8 using Ethernet frame. And the downstream PCI Express-Ethernet bridge 7 transmits the encapsulated I/O packet to the Ethernet switch 200 in which the upstream PCI Express-Ethernet bridge 15 is set as the destination. The upstream PCI Express-Ethernet bridge 15 receives the Ethernet frame which encapsulates the I/O packet and decapsulates the I/O packet. The upstream PCI Express-Ethernet bridge 15 transmits the I/O packet to the route complex 121.

The route complex 121 receives an I/O packet and transmits the I/O packet to the CPU 11 or the memory 13. The I/O packet performs the designated processing such as interrupt control for the CPU 11 and DMA (Direct Memory Access) control for the memory 13.

Patent document 2 describes the sharing system whose configuration is similar to the patent document 1 in which CPU and I/O device are connected via an upstream PCI Express bridge, a network and a downstream PCI Express-Ethernet bridge.

Patent document 3 describes the system which includes a NIC (Network Interface Card) for the working system and a NIC for the standby system, and changes the working NIC to standby NIC for continuous operation when a failure takes place in the working NIC.

### THE PRECEDING TECHNICAL LITERATURE

### Patent Document

[Patent document 1] Japanese Patent Application Laid-Open No. 2007-219873 ([0028] paragraph and FIG. 1)

[Patent document 2] Japanese Patent Application Laid-Open No. 2008-078887 ([0020] paragraph)

[Patent document 3] Japanese Patent Application Laid-Open No. 2003-078567 ([0012] paragraph)

### SUMMARY

An exemplary object of the invention is to provide a network apparatus, a network configuration method and a program recording medium which records a network apparatus program which make the flexible bus connection between the host and the peripheral device possible.

A network apparatus of the present invention includes a first interface unit which connects a host which holds a plurality of I/O buses and the network apparatus via a network, a second interface unit which connects a peripheral device which holds a plurality of I/O interfaces and the network apparatus, and a control unit which controls the plurality of I/O interfaces to be connected to branches of the different I/O buses respectively.

A network system of the present invention includes a host that holds a plurality of I/O buses, a peripheral device that includes a plurality of I/O interface, a first interface unit which connects the host and an own apparatus via a network, a second interface unit which connects the peripheral device and the apparatus and a control unit which controls the plurality of I/O interfaces to be connected to the branches of different I/O buses respectively.

A network configuration method of the present invention includes connecting a host which includes a plurality of I/O buses and an own network apparatus via a network, connecting a peripheral device which includes a plurality of I/O interfaces and the network apparatus and controlling the plurality of I/O interfaces to be connected to branches of the different I/O buses respectively.

A program recording medium of the present invention records a network apparatus program tangibly in order to perform the function as the first interface unit which connects a host including a plurality of I/O buses and an own network apparatus via a network, a second interface unit which connects a peripheral device including a plurality of I/O interfaces and the network apparatus, and a control unit which controls the plurality of I/O interfaces to be connected to branches of the different I/O buses respectively.

### BRIEF DESCRIPTION OF THE DRAWINGS

Exemplary features and advantages of the present invention will become apparent from the following detailed description when taken with the accompanying drawings in which:

FIG. 1 is a figure showing the structure of the network system of the first exemplary embodiment;

FIG. 2 is a figure showing a device tree of the host in the first exemplary embodiment;

FIG. 3 is a figure showing the structure of the Ethernet frame with the encapsulated I/O packet of PCI Express;

FIG. 4 is a figure showing an example of an address conversion table;

FIG. 5 is a figure illustrating an example of an address conversion of an I/O packet issued by the host;

FIG. 6 is a figure illustrating an example of an address conversion of the I/O packet issued by VF;

FIG. 7 is a figure showing an example of the structure of a virtual resource register;

FIG. 8 is a figure showing an example of the contents in the virtual VF register;

FIG. 9 is a flow chart illustrating operation of a connected host control unit;

FIG. 10 is a flow chart illustrating the operation of an address allocation unit;

FIG. 11 is a figure showing a software stack which operates on the CPU equipped on a host;

FIG. 12 is a flow chart showing the host operation which issues an I/O packet in an SR-IOV adaptable I/O;

FIG. 13 is a flow chart illustrating the operation that the downstream PCI Express-Ethernet bridge processes an I/O packet which the host has issued;

FIG. 14 is a flow chart showing the operation that the downstream PCI Express-Ethernet bridge processes an I/O packet which the SR-IOV adaptable I/O has issued;

FIG. 15 is a flow chart illustrating the operation for processing the I/O packet which the SR-IOV adaptable I/O has issued;

FIG. 16 is a figure showing the structure of the network apparatus of the second exemplary embodiment;

FIG. 17 is a figure showing an example of the network system in relation to the present invention disclosed in patent document 1; and

FIG. 18 is a flow chart illustrating the operation in an address corresponding unit.

### EXEMPLARY EMBODIMENT

Next, the embodiment of the present invention will be described in detail with reference to a drawing.

### The First Exemplary Embodiment

The first exemplary embodiment of the present invention will be described.

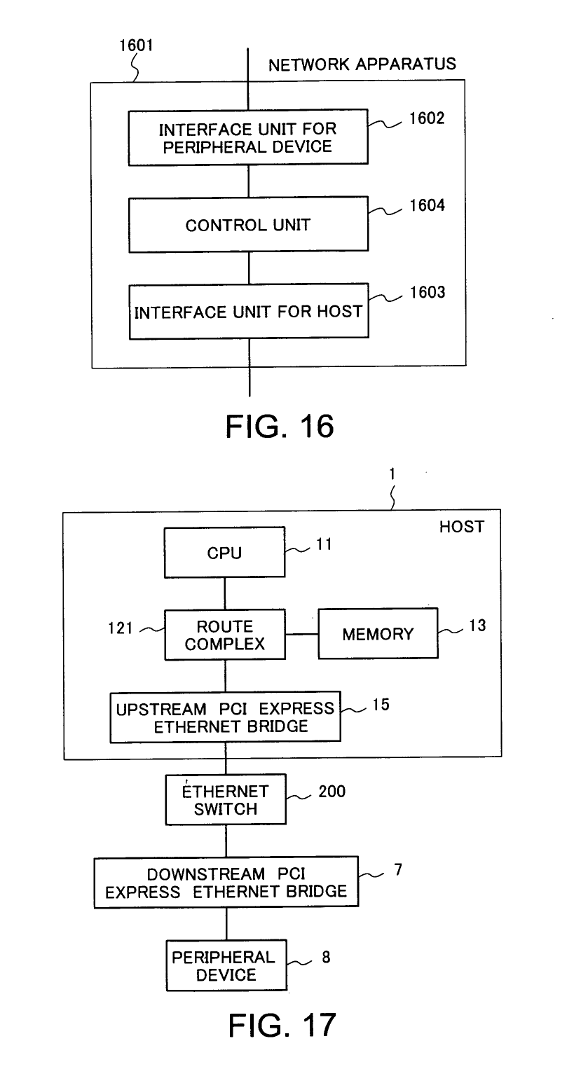

FIG. 16 is a figure showing the structure of the network apparatus of the first exemplary embodiment of the present invention. Network apparatus 1601 includes an interface unit 1602 for a peripheral device, an interface unit 1603 for a host and a control unit 1604. The control unit 1604 controls a plurality of I/O interfaces accessed from the software provided in the peripheral device in order to connect the respective different I/O buses that are held by the host connected to the peripheral device.

The control unit 1604 controls the I/O device corresponding to each I/O interface of a peripheral device which holds a plurality of interfaces so that the I/O device will belong to the I/O bus whose peripheral devices are different from the host view point. As a result, control unit 1604 can make the host recognize that the I/O interface connection status shall be the configuration that a plurality of I/O devices connected to the same peripheral device are connected respectively to different buses.

Consequently, the first exemplary embodiment provides the effect that the communication route between the host and the peripheral device can be controlled flexibly.

As the first modification of the first exemplary embodiment, one of a plurality of I/O devices may operate as the working system and the others may operate as the standby system. In this case, when failures occur on the route corresponding to an I/O device in the working system, the working I/O device may be switched to the standby I/O device.

As a result, moreover, the modified embodiment of the first exemplary embodiment provides the effects that the fast system switching is made possible for the packet transmission system with the redundant structure, in addition to the original effect of the first exemplary embodiment.

As the second different modification of the first exemplary embodiment, a plurality of I/O devices may be operated simultaneously as the active system. In this case, the data volume among the plural I/O devices may be controlled by load balancing technology.

As a result, moreover, the second modification of the first exemplary embodiment provides the effects that the load balancing is easily performed in addition to the effect described in the first exemplary embodiment.

### The Second Exemplary Embodiment

Next, the second exemplary embodiment of the present invention will be described. In the second exemplary embodiment, a network apparatus of the present invention will be described more in detail.

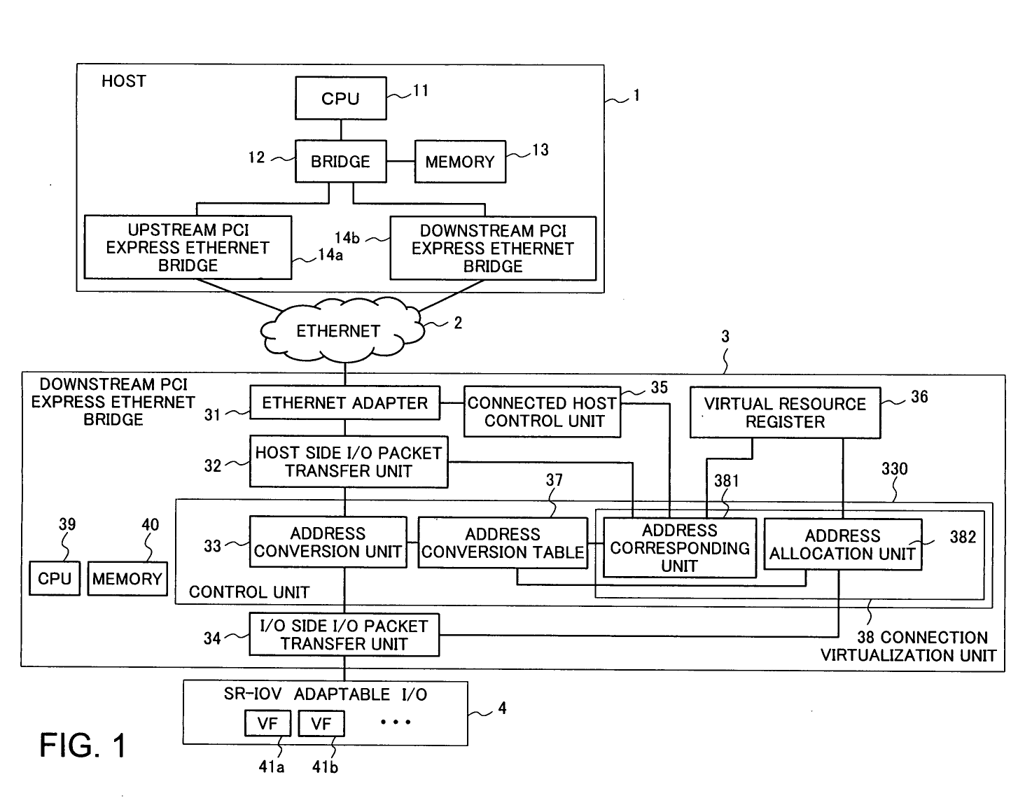

FIG. 1 is a figure showing the structure of the network system of the second exemplary embodiment of the present invention. Referring to FIG. 1, a computer system of the second exemplary embodiment includes a host 1, Ethernet 2, a downstream PCI Express Ethernet bridge 3 and a SR-IOV (Single Root I/O Virtualization) adaptable I/O 4. The SR-IOV adaptable I/O 4 is a peripheral device based upon SR-IOV. Here, SR-IOV is the specification concerning the I/O device of PCI Express which PCI-SIG defines for realizing the access to the I/O device from a plurality of VMs (Virtual Machines) by controlling the I/O device. And the peripheral device based upon SR-IOV is used by the insertion in the I/O slot of the operating host in which plural VMs work. Each VM directly issues the I/O instructions to assigned VF without the operation of the mediation layer of the software. As a result, the overhead concerning I/O processing can be reduced.

The host 1 includes a CPU 11, a bridge 12, a memory 13 and an upstream PCI Express Ethernet bridges 14a and 14b. The upstream PCI Express-Ethernet bridges 14a and 14b are the network interfaces of the host 1 to the Ethernet 2. Further, the upstream PCI Express Ethernet bridge 14a and the upstream PCI Express Ethernet bridge 14b may be the same. In order to identify these devices, the subscripts of the upstream PCI Express-Ethernet bridge 14 is set to “a” and “b”.

Here, SR-IOV adaptable I/O 4 is equipped with a plurality of interfaces which the software on the host 1 can access. These plural interfaces are called VF (Virtual Function) respectively. In FIG. 1, in order to classify a plurality of interfaces, each VF is noted with VF 41a and VF 41b.

In the second exemplary embodiment, the VF 41a and VF 41b are assigned to the host 1. The VF 41a is assigned so as to be connected to the host 1 from the downstream PCI Express-Ethernet bridge 3 via the upstream PCI Express Ethernet bridge 14a. On the other hand, the VF 41b is assigned so as to be connected to the host 1 from the downstream PCI Express-Ethernet bridge 3 via the upstream PCI Express Ethernet bridge 14b.

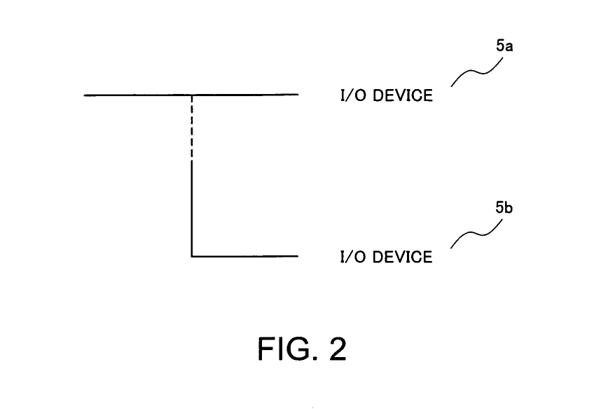

FIG. 2 is a figure showing the device tree of host 1 in the second exemplary embodiment. The VF 41a and VF 41b of SR-IOV adaptable I/O 4 belong to the different PCI Express buses which are related to the upstream PCI Express Ethernet bridge 14a and the upstream PCI Express Ethernet bridge 14b respectively. For this reason, the device tree of the host 1 is constituted so that the I/O function (hereinafter, referred to as I/O device) which the SR-IOV adaptable I/O 4 provides may be equipped to one by one different bus.

In FIG. 1, the downstream PCI Express-Ethernet bridge 3 is the network apparatus having an Ethernet adapter 31, a host side I/O packet transfer unit 32, a control unit 330 and an I/O side I/O packet transfer unit 34. And further, the downstream PCI Express-Ethernet bridge 3 includes a connected host control unit 35 and a virtual resource register 36. Here, the control unit 330 includes an address conversion unit 33, an address conversion table 37 and a connection virtualization unit 38. Further, the connection virtualization unit 38 includes an address corresponding unit 381 and an address allocation unit 382. Furthermore, the downstream the PCI Express-Ethernet bridge 3 may include a CPU 39 and a memory 40 in addition.

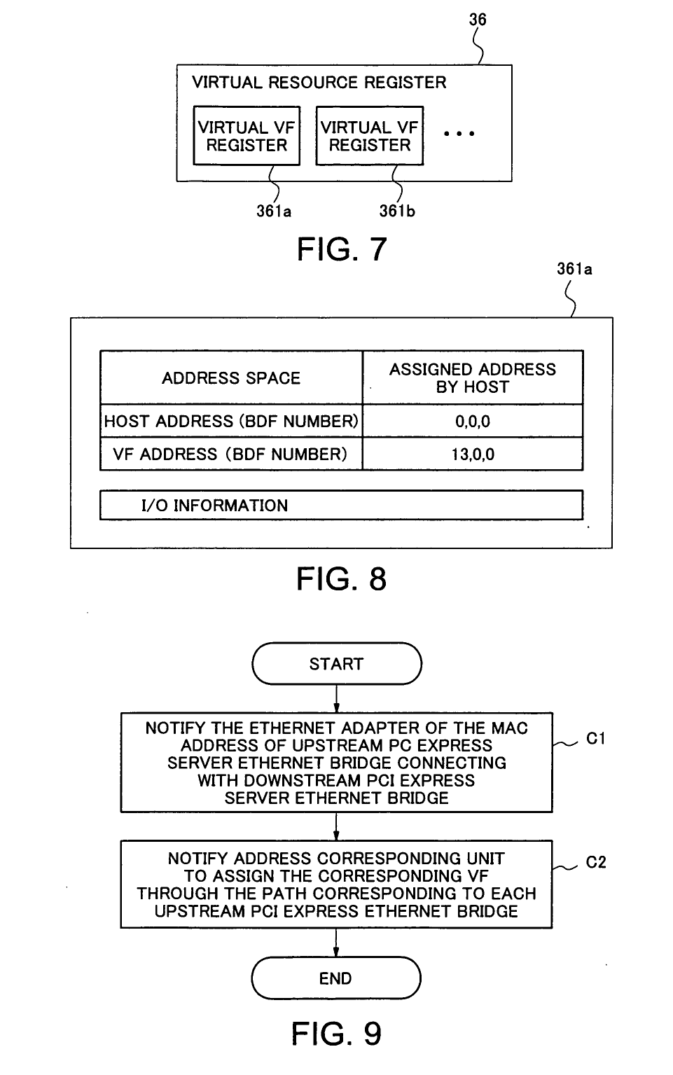

The Ethernet adapter 31 performs the encapsulation processing for the I/O packets to Ethernet frames. The host side I/O packet transfer unit 32 transmits an I/O packet to the appropriate destination. The address conversion unit 33 converts an address indicated in an I/O packet. The I/O side I/O packet transfer unit 34 transmits an I/O packet to the appropriate destination. The connected host control unit 35 controls the connection between the downstream PCI Express-Ethernet bridge 3 and the upstream PCI Express Ethernet bridges 14a, 14b. As shown in FIG. 7, the virtual resource register 36 includes a virtual VF registers 361a and 361b used for each VF control. The configuration of the virtual resource register 36 will be described using FIG. 7 later. The address conversion table 37 is used when the address conversion unit 33 converts the address described in an I/O packet. The address corresponding unit 381 and the address allocation unit 382 control the connection between host 1 and SR-IOV adaptable I/O 4.

The operation in each unit will be described more in detail below.

The Ethernet adapter 31 receives the Ethernet frame which encapsulates an I/O packet of the PCI Express from Ethernet 2 and decapsulates the received I/O packet. The Ethernet adapter 31 transmits the I/O packet to the host side I/O packet transfer unit 32 as well as the information which identifies the upstream PCI Express Ethernet bridge which has received the Ethernet frame.

The Ethernet adapter 31 receives the I/O packet which the SR-IOV adaptable I/O 4 has issued from the host side I/O packet transfer unit 32 and the information which identifies the source VF. When the source of the I/O packet is VF 41a, The Ethernet adapter 31 encapsulates the I/O packet to an Ethernet frame using a MAC (Media Access Control) address in the upstream PCI Express Ethernet bridge 14a and transmits it to the Ethernet network 2.

When the source of an I/O packet is the VF 41b, The Ethernet adapter 31 encapsulates an I/O packet to an Ethernet frame using a MAC address in the upstream PCI Express Ethernet bridge 14b and transmits it to the Ethernet 2.

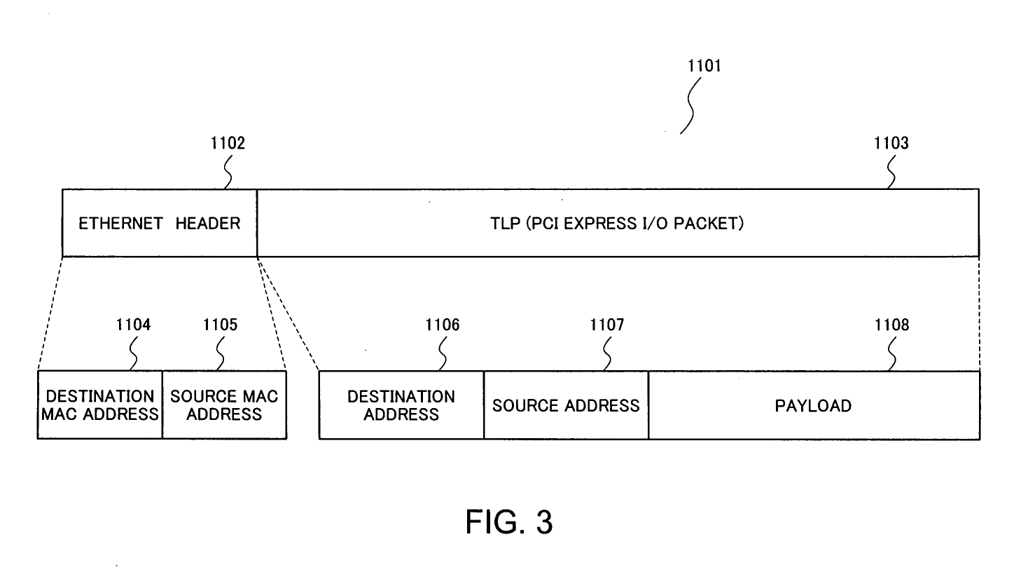

FIG. 3 is a figure showing the frame structure of the Ethernet frame which encapsulates an I/O packet of the PCI Express. FIG. 3 shows the structure of Ethernet frame 1101 including an Ethernet header 1102 and a TLP (Transaction Layer Packet) 1103. The Ethernet header 1102 is the header of the Ethernet frame 1101. The Ethernet header 1102 includes destination MAC address 1104 and source MAC address 1105. TLP 1103 is an I/O packet of the PCI Express. The I/O packet of the PCI Express includes destination address 1106 of the packet, source address 1107 of the packet and payload 1108.

In the PCI Express, three kinds of addresses that are a mapped I/O address in the I/O space of the host, a memory address mapped in the memory space of the host and an ID number can be used as the address which is assigned to the connected device. The ID number includes the set of the bus number, the device number and the function number. Hereinafter, a set of these numbers which compose the ID number is called “the BDF number”.

Address routing which specifies the destination memory address or the destination I/O address and ID routing which specifies the destination ID number can be used for addressing of an I/O packet. And as the destination address 1106 of a packet and source address 1107 of a packet, the memory address, the I/O address and the ID number described above can be used in a combination manner.

The I/O packet encapsulated by the Ethernet frame shown in FIG. 3 is transmitted between Ethernet adapter 31 and upstream PCI Express-Ethernet bridges 14a, 14b.

The host side I/O packet transfer unit 32 receives the I/O packet and the identification information of the upstream PCI Express-Ethernet bridge where the I/O packet travels from the Ethernet adapter 31. When the received I/O packet is a packet concerning the address control of the SR-IOV adaptable I/O 4 by the host 1, the host side I/O packet transfer unit 31 transmits a received I/O packet to the address corresponding unit 381. When the received I/O packet is the other I/O packet than that, the host side I/O packet transfer unit 31 transmits the received I/O packet to the address conversion unit 33. The received I/O packet is transferred to the destination with the identification information of the upstream PCI Express Ethernet bridge which transmits the I/O packet in both cases. Here, the identification information of the upstream PCI Express-Ethernet bridge which is transferred with the I/O packet may be included in the I/O packet.

The MAC address of the upstream PCI Express-Ethernet bridge or the information corresponding to the MAC address may be used as the identification information of the upstream PCI Express-Ethernet bridge. Otherwise, the host side I/O packet transfer unit 32 may deal with the other information which can identify the upstream PCI Express-Ethernet bridge as the identification information of the upstream PCI Express-Ethernet bridge. For example, the number assigned sequentially to the upstream PCI Express-Ethernet bridge may be used as the identification information.

As an example of an I/O packet concerning the address control, there are a configuration read packet and a configuration write packet defined by the PCI Express. The configuration read packet is used for reading the address value set in the SR-IOV adaptable I/O 4 while the configuration write packet is used for writing the address value in the SR-IOV adaptable I/O 4.

Host side I/O packet transfer unit 32 receives an I/O packet which the VF 41a or VF 41b has issued and a VF identification number for identifying the source VF from the address conversion unit. And then, host side I/O packet transfer unit 32 transmits an I/O packet which the VF 41a or VF 41b has issued and the VF identification number to the Ethernet adapter 31. Further, the I/O packet may include the VF identification number which has issued the own packet.

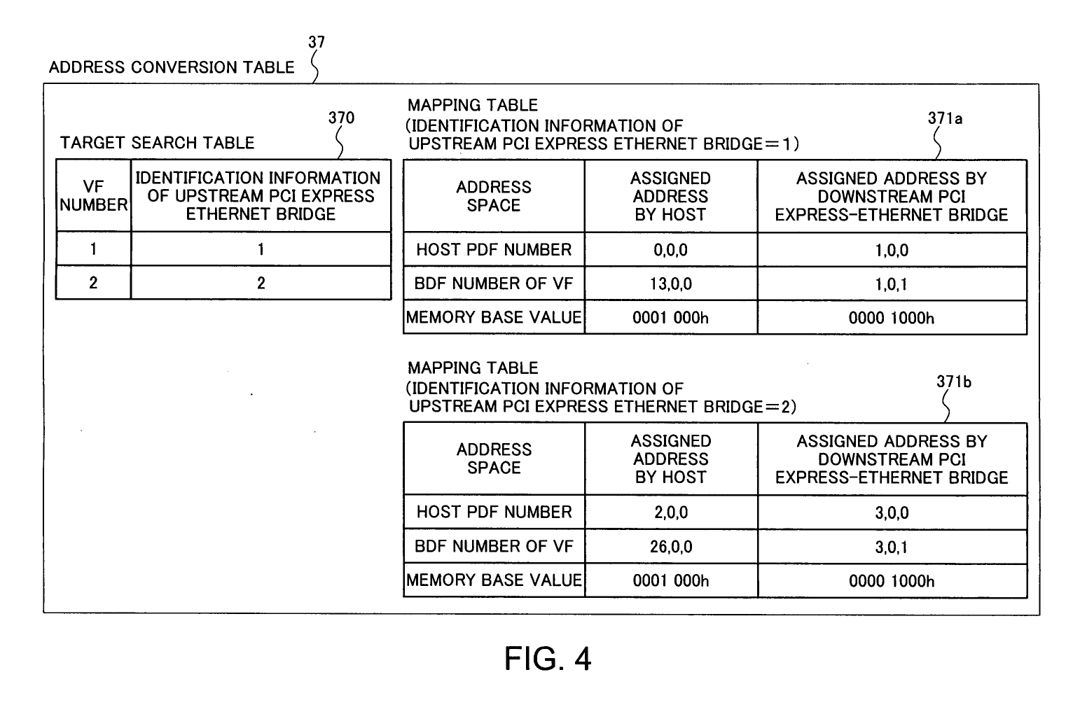

FIG. 4 shows an example of the address conversion table 37 which is referred by the address conversion unit 33. The address conversion table 37 includes a target search table 370 and a plurality of mapping tables 371a, 371b. The address conversion unit 33 changes the address of an I/O packet by referring to address conversion table 37.

The target search table 370 includes the information which indicates the corresponding relationship between the VF number and the identification information of the upstream PCI Express-Ethernet bridge. The target search table 370 of FIG. 4 represents that VF whose VF number is 1 corresponds to the upstream PCI Express-Ethernet bridge whose identification information is 1 and VF whose VF number is 2 corresponds to the upstream PCI Express-Ethernet bridge whose identification information is 2.

The mapping tables 371a and 371b include a plurality of tables provided for each identification information of the upstream PCI Express-Ethernet bridge. In order to classify a plurality of these mapping tables, each mapping table is noted with the mapping table 371a or the mapping table 371b. In this exemplary embodiment, the case that the number of the upstream PCI Express-Ethernet bridges is two will be described. Accordingly, two mapping tables are used. However, in the case that three or more upstream PCI Express-Ethernet bridges exist, the number of the mapping tables may be increased depending on the number of upstream PCI Express-Ethernet bridges.

Next, the contents of the mapping table will be described using the mapping table 371a as an example.

The mapping table 371a is used in case that an address conversion of I/O packets pass through the upstream PCI Express Ethernet bridge whose identification information is 1. The mapping table 371a includes the BDF number of the host and the BDF number of VF. The mapping table 371a may include the memory base value used for the memory address conversion. And the mapping table 371a holds the address which the host has assigned and the address which downstream PCI Express-Ethernet bridge 3 has assigned respectively concerning these addresses. The address assignment operations by the host and downstream PCI Express-Ethernet bridge 3 will be described later.

The address conversion unit 33 refers to target search table 370 and the mapping tables 371a, 371b. As a result, the address conversion unit 33 can get the corresponding information between the VF number and the upstream PCI Express-Ethernet bridge. The address conversion unit 33 also can get the corresponding information between the address which the host assigned for each upstream PCI Express-Ethernet bridge and the address which the downstream PCI Express-Ethernet bridge assigned.

The destination address of an I/O packet transmitted to the SR-IOV adaptable I/O 4 from the host 1 is converted in the address conversion unit 33 as follows. That is, in address conversion unit 33, the destination address of an I/O packet is converted to the address which the downstream PCI Express-Ethernet bridge 3 assigns to VF 41a and VF 41b from the address which host 1 assigns to the VF 41a and VF 41b at the start-up time respectively.

And in address conversion unit 33, the source address of an I/O packet transmitted to SR-IOV adaptable I/O 4 from the host is converted from the address given in the host 1 into the address of downstream PCI Express-Ethernet bridge 3.

The operation of the address conversion unit 33 is described below in detail. When receiving the I/O packet from the host 1 via the upstream PCI Express Ethernet bridge 14a (the identification information is made “1”), the address conversion unit 33 reads from the received packet that the identification information of the upstream PCI Express-Ethernet bridge 14a is “1”. As a result, the address conversion unit 33 refers to the mapping table 371a corresponding to the identification information “1” of the upstream PCI Express-Ethernet bridge 14a.

On the other hand, the operation is as follows when the address conversion unit 33 receives the I/O packet from the host 1 via the upstream PCI Express Ethernet bridge 14b (the identification number is made “2”). That is, the address conversion unit 33 reads from the received packet that identification information of the upstream PCI Express-Ethernet bridge 14b is “2”. As a result, the address conversion unit 33 refers to the mapping table 371b corresponding to the identification information “2” of the upstream PCI Express-Ethernet bridge 14b.

The target search table 370 is used so that the address conversion unit 33 will designate the destination of the upstream PCI Express-Ethernet bridge which corresponds to the VF number of the I/O packet transmitted from the SR-IOV adaptable I/O 4 to the host 1.

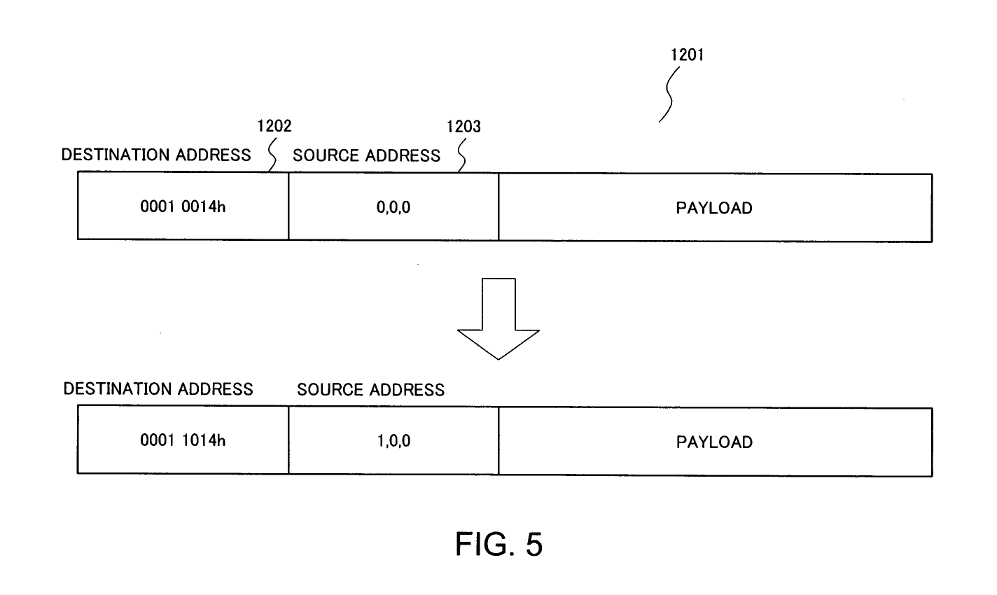

FIG. 5 illustrates an example of an address conversion of the I/O packet which the host 1 issues. A procedure of the address conversion in detail will be described using FIG. 5.

Further, FIG. 5 shows an example that the identification information of the upstream PCI Express Ethernet bridge in I/O packet 1201 is “1”. That is, it is supposed that I/O packet 1201 is transmitted via upstream PCI Express-Ethernet bridge 14a.

The I/O packet 1201 shown in FIG. 5 indicates the case that the destination address 1202 is designated by the address routing and the source address 1203 of a packet is designated by the ID number. That is, the I/O packet 1201 stores the memory address as the destination address 1202 and the host BDF number as the source address 1203, respectively.

At the time when the address conversion unit 33 receives the I/O packet 1201 from the host side I/O packet transfer unit 32, the destination address 1202 and the source address 1203 are “0001 0014h” and “0, 0, 0”, respectively. And the address conversion unit 33 refers to the mapping table 371a whose identification information is “1” as illustrated in FIG. 4, because the identification information of the upstream PCI Express-Ethernet bridge of I/O packet 1201 is “1”.

The address conversion unit 33 changes the destination address 1202 of the I/O packet 1201 into “0000 1014h” based on the memory base values “0001 0000h” and “0000 1000h” with reference to the mapping table 371a. And the source address 1203 of the I/O packet 1201 is rewritten from “0, 0, 0” which the host 1 has assigned into “1, 0, 0” which the downstream PCI Express-Ethernet bridge has assigned. By this address conversion, each VF can deal with the I/O packet 1201 as the packet which has been transmitted by the downstream PCI Express Ethernet bridge.

Here, in FIG. 5, the destination address of the I/O packet 1201 is set to be address routing. However, the routing scheme by the BDF number may be used as a destination address routing method. When the routing scheme by the BDF number is employed, the BDF number may be converted from the BDF number that the host 1 designates into the BDF number that the downstream PCI Express-Ethernet bridge designates in address conversion unit 33.

Next, a procedure of the address conversion of an I/O packet which the SR-IOV adaptable I/O 4 has issued for the host 1 in address conversion unit 33 will be described.

The address conversion unit 33 receives an I/O packet which the SR-IOV adaptable I/O 4 has issued, from the I/O side I/O packet transfer unit 34. And the address conversion unit 33 converts an address indicated in the I/O packet and transmits it with the identification number of VF which has issued an I/O packet to the host side I/O packet transfer unit 32.

Here, when receiving the I/O packet transmitted from SR-IOV adaptable I/O 4, the address conversion unit 33 converts the source address of the I/O packet from the address which downstream PCI Express-Ethernet bridge 3 assigned to the source VF to the address which host 1 assigned to source VF.

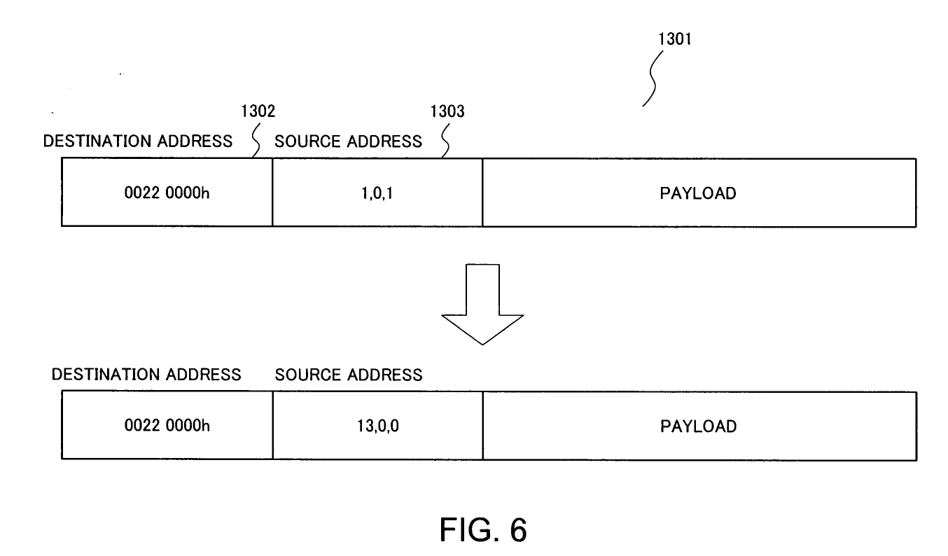

FIG. 6 is a figure illustrating an example of the address conversion of an I/O packet which VF 41 issues. An example of the address conversion procedure in detail will be described using FIG. 6.

It is supposed that the routing method of the I/O packet 1301 which SR-IOV adaptable I/O 4 issues is similar to the method for the I/O packet 1201 described in FIG. 5. That is, the I/O packet 1301 designates the destination address 1302 with a memory address and designates the source address 1303 with the BDF number. In FIG. 6, the case that the source of the I/O packet 1301 is the VF 41a whose VF number is “1” will be described.

At the time when the address conversion unit 33 receives the I/O packet 1301 from the I/O side I/O packet transfer unit 34, the destination address 1302 and source address 1303 of the I/O packet 1301 are set “0022 0000h” and “1,0,1”, respectively. The address conversion unit 33 refers to the target search table 370 of FIG. 4. Because the source VF number of the I/O packet 1301 is “1”, the address conversion unit 33 knows that identification number of the upstream PCI Express-Ethernet bridge through which the I/O packet pass is “1”. For this reason, the address conversion unit 33 refers to the mapping table 371a whose identification information is “1”.

BDF number of “1, 0, 1” is set as source address of I/O packet 1301. The BDF number corresponds to the VF which has VF number 1 assigned by the downstream PCI Express-Ethernet bridge. And “0022 0000h” is set as the destination address 1302 of the I/O packet 1301.

The address conversion unit 33 changes the source address 1303 of the I/O packet 1301 into “13, 0, 0” which has been assigned by the host 1 from “1, 0, 1” which the downstream PCI Express-Ethernet bridge has assigned with reference to the mapping table 371a. By this address conversion, the host 1 can deal with the I/O packet 1301 as the packet which the downstream PCI Express-packet Ethernet bridge 3 has transmitted.

Further, the destination address 1302 (“0022 0000h”) is not rewritten into the address conversion of the I/O packet 1301, in the description mentioned above. This is because the DMA access to the destination memory of the I/O packet 1301 is performed. That is, this is because the address conversion is not needed in the address conversion unit, since the address of the host address space has already been assigned as the destination address at the time of generating the I/O packet in DMA case. The configuration may be employed that the destination address 1302 of the I/O packet 1301 is converted from the address space of the downstream PCI Express-Ethernet bridge to the address space of the host 1, by using the inverse procedures to the source address conversion described in FIG. 5.

Here, in FIG. 6, the destination address of I/O packet 1201 is used for address routing. However, the routing scheme by the BDF number may be used as a destination address routing method. When the routing scheme by the BDF number is employed, the BDF number may be converted from the BDF number that the host 1 designates into the BDF number that the downstream PCI Express-Ethernet bridge designates in address conversion unit 33.

In the exemplary embodiments described in FIG. 5 and FIG. 6, the configuration in the address conversion unit 33 is employed that the source address of the I/O packet can be rewritten between the address which the host 1 has assigned and the address which the downstream PCI Express-Ethernet bridge 3 has assigned. Here, the I/O packet is the I/O packet transmitted from the host 1 or SR-IOV adaptable I/O 4. However, the configuration may be employed that the address conversion unit directly transfers the I/O packet without converting the source address if the destination of the I/O packet can dispose the I/O packet without converting the source address.

The numerical value which is indicated in the address conversion table 37 mentioned above is just an example and the notation by other numerical values or character strings is also possible. For example, MAC addresses may be used as identification information of the upstream PCI Express-Ethernet bridge.

The I/O side I/O packet transfer unit 34 receives the I/O packet which the host 1 has issued from the address conversion unit 33 and transmits it to a VF which the SR-IOV adaptable I/O 4 designates.

The I/O side I/O packet transfer unit 34 receives the I/O packet from a VF of SR-IOV adaptable I/O 4. And the I/O side I/O packet transfer unit 34 transmits the received I/O packet to the address allocation unit 382 if the received I/O packet relates to the control for the address which the downstream PCI Express Ethernet bridge assigns to the SR-IOV adaptable I/O 4. When it is the other I/O packet, the I/O side I/O packet transfer unit 34 transmits the received I/O packet to address conversion unit 33.

The connected host control unit 35 manages the connection between the downstream PCI Express Ethernet bridge 3 and the upstream PCI Express Ethernet bridges 14a, 14b.

The upstream PCI Express-Ethernet bridges 14a and 14b periodically broadcast their own identification information including MAC addresses to the downstream PCI Express-Ethernet bridge 3. The connected host control unit 35 receives the identification information of the upstream PCI Express-Ethernet bridge which is broadcast from the upstream PCI Express Ethernet bridges 14a and 14b. And the connected host control unit 35 notifies the MAC addresses of upstream PCI Express Ethernet bridge 14a and upstream PCI Express Ethernet bridge 14b which are connected to the downstream PCI Express Ethernet bridge 3, to the Ethernet adapter 31. The connected host control unit 35 performs this notification before the host 1 begins to use the SR-IOV adaptable I/O 4. The Ethernet adapter 31 encapsulates an I/O packet using notified MAC address.

On the other hand, the connected host control unit 35 assigns VF 41a to the route, corresponding to upstream PCI Express Ethernet bridge 14a, and informs the address corresponding unit 381 to assign VF 41b to the route corresponding to the upstream PCI Express Ethernet bridge 14b.

The connection virtualization unit 38 includes the address corresponding unit 381 and the address allocation unit 382. The address corresponding unit 381 receives the information concerning the correspondence of each VF and host, from the connected host control unit 35. The address corresponding unit 381 receives the configuration read packet and the configuration write packet which the host 1 has issued, from the host side I/O packet transfer unit 32 to each VF. And address corresponding unit 381 makes the received configuration read packet read the value of virtual resource register 36 corresponding to VF designated by the packet. The address corresponding unit 381 writes the value that is designated by the received configuration write packet into the virtual VF register corresponding to the VF designated by the packet. The address corresponding unit 381 registers the address information assigned by the host 1 which is indicated in the virtual VF register, in the mapping table of corresponding VF.

The address allocation unit 382 issues an I/O packet which concerns the address control via the I/O side I/O packet transfer unit 34 to SR-IOV adaptable I/O 4 and collects the I/O information of SR-IOV adaptable I/O 4 before host 1 begins to use the SR-IOV adaptable I/O 4. And the address allocation unit 382 assigns the address which the I/O information requests to the VF 41a and VF 41b. The address allocation unit 382 registers the address of VF 41a which the address allocation unit 382 has assigned in the mapping table 371a and registers the address of VF 41b in mapping table 371b. The address allocation unit 382 reflects the acquired I/O information in the virtual resource register 36. In the mapping table, the address which the allocation unit 382 assigns corresponds to the address which the downstream PCI Express-Ethernet bridge assigns.

FIG. 7 shows an example of the structure of the virtual resource register 36. The virtual resource register 36 includes virtual VF registers 361a and 361b used for the control of each VF. The address space and the device information which these virtual VF registers request are set by the address allocation unit 382. The access from the host 1 to the virtual VF register is performed by the control of the address corresponding unit 381 only to the register corresponding to VF which the connected host control unit 35 has assigned to host 1. The value set by the host 1 to the virtual VF register for assigning the address to each VF, is reflected in address conversion table 37.

In FIG. 7, the virtual VF register is noted as virtual VF register 361a and virtual VF register 361b. It is supposed that the virtual VF register 361a corresponds to the VF 41a and the virtual VF register 361b corresponds to VF 41b respectively. And the addresses which the host 1 has assigned to the VF 41a and VF 41b and the information of the I/O device corresponding to each VF (hereinafter, referred to as “I/O information”) are described in the virtual VF register 361a and the virtual VF register 361b, respectively.

When the host 1 is started or SR-IOV adaptable I/O 4 is set in the hot-plug state by the host 1, host 1 transmits the configuration read packet to the I/O bus when address allocation processing begins. And the host 1 acquires the I/O information connected to the branch of each I/O bus from the response of the configuration read packet. The operation will be described below.

The host 1 reads the virtual VF registers 361a and 361b using the configuration read packet. When the I/O device exists in the branch of the I/O bus, the I/O information is returned to the host 1 as the response of the configuration read packet.

The address corresponding unit 381 makes the configuration read packet received from the host 1 via the upstream PCI Express Ethernet bridge 14a read the value of the virtual VF register 361a designated by a packet. The I/O information corresponding to the VF 41a is indicated in the virtual VF register 361a. And the address corresponding unit 381 replies the response of the configuration read packet to the host 1.

Similarly, the address corresponding unit 381 makes the configuration read packet received via upstream PCI Express Ethernet bridge 14b from host 1 read virtual VF register 361b designated by a packet. The I/O information corresponding to VF 41b is indicated in the virtual VF register 361b. And the address corresponding unit 381 replies the response of the configuration read packet to the host 1.

Host 1 gets the corresponding information on the I/O bus and the I/O information of its branch from the response of the configuration read packet through each I/O bus.

As a result, VF 41a and VF 41b are controlled in order to belong to the I/O bus concerning the upstream PCI Express Ethernet bridges 14a and 14b respectively from the view point of the host 1. That is, from the view point of the host 1, the VF 41a belongs to the I/O bus which goes through the upstream PCI Express Ethernet bridge 14a and the VF 41b belongs to the I/O bus which goes through the upstream PCI Express Ethernet bridge 14b.

The address corresponding unit 381 receives the I/O packet which the host 1 has issued to assign the address to VF 41a, via the upstream PCI Express Ethernet bridge 14a. Furthermore, in order to assign the address to the VF 41b, the address corresponding unit 381 receives an I/O packet which the host 1 has issued via the upstream PCI Express Ethernet bridge 14b.

And, for using SR-IOV adaptable I/O 4 the host 1 assigns an address to SR-IOV adaptable I/O 4 according to the following procedure. That is, the host 1 assigns the address to the VF 41a by writing the address in the virtual VF register 361a using the configuration write packet. Similarly, the host 1 assigns then address to the VF 41b by writing the address in the virtual VF register 361b using the configuration write packet.

FIG. 8 is a figure showing an example of the contents in the virtual VF register 361a. The addresses of the host 1 and the VF which the host 1 has assigned concerning the VF 41a is written in the virtual VF register 361a. The I/O information of the I/O device corresponding to the VF is also indicated in the virtual VF register 361a. The virtual VF register 361b in which the address concerning the VF 41b is written has also the same configuration.

The address corresponding unit 381 registers the address information which is assigned by the host 1 and indicated in the virtual VF register 361a into the mapping table 371a. Similarly, the address corresponding unit 381 registers the address information which is assigned by the host 1 indicated in the virtual VF register 361b into the mapping table 371b.

The operation of the connected host control unit 35 and the connection virtualization unit 38 mentioned above will be described below using a flow chart.

FIG. 9 is a flow chart illustrating the operation of the connected host control unit 35. The connected host control unit 35 notifies the Ethernet adapter 31 of the MAC addresses of the upstream PCI Express Ethernet bridge 14a and the upstream PCI Express Ethernet bridge 14b which are connected to the downstream PCI Express Ethernet bridge 3 before the host 1 begins to use the SR-IOV adaptable I/O 4 (Step C1).

The connected host control unit 35 notifies the address corresponding unit 381 to assign the VF 41a to the route which is corresponding to upstream PCI Express Ethernet bridge 14a, and to assign VF 41b to the route which is corresponding to the upstream PCI Express Ethernet bridge 14b (Step C2).

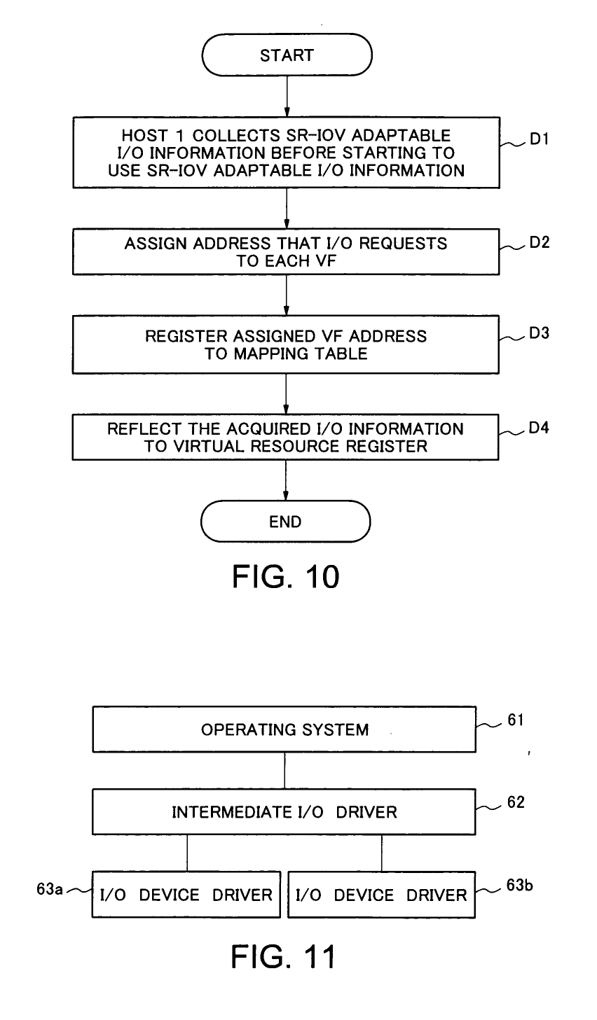

FIG. 10 is a flow chart illustrating the operation of address allocation unit 382.

In FIG. 10, the address allocation unit 382 issues the I/O packet concerning the address control for the SR-IOV adaptable I/O 4 via the I/O side I/O packet transfer unit 34 and collects the I/O information of SR-IOV adaptable I/O 4 before the host 1 begins to use the SR-IOV adaptable I/O 4 (Step D1). Here, the address allocation unit 382 performs the operation of Step D1 before the host 1 begins to use the SR-IOV adaptable I/O 4. And the address allocation unit 382 assigns the address which the I/O requests to each VF based on the collected information (Step D2). And the address allocation unit 382 registers the address of each assigned VF into the mapping table (Step D3). The address allocation unit 382 reflects the acquired I/O information in the virtual resource register 36 (Step D4).

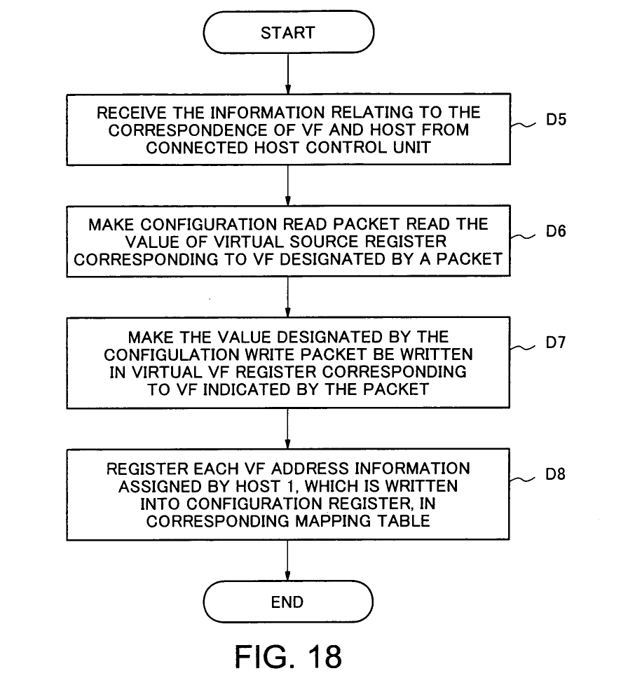

FIG. 18 is a flow chart illustrating the operation of the address corresponding unit 381.

In FIG. 18, when the host 1 is started or SR-IOV adaptable I/O 4 is set in a hot plug state by the host 1, the address corresponding unit 381 receives the information related to the correspondence of VF and the host from the connected host control unit 35 (Step D5). The address corresponding unit 381 makes the configuration read packet read the value of the virtual resource register corresponding to the VF designated by a packet (Step D6). And the address corresponding unit 381 makes the value designated by the configuration write packet be written in the virtual VF register corresponding to the VF designated by a packet (Step D7). The address corresponding unit 381 registers the address information of each VF which is written in the virtual VF register and assigned by host 1 into the mapping table corresponding to each VF (Step D8). As a result, from the view point of the host 1, the address corresponding unit 381 controls VF 41a and 41b to belong to the I/O bus concerning upstream PCI Express Ethernet bridges 14a and 14b.

Here, the downstream PCI Express Ethernet bridge 3 may include a CPU 39 and a memory 40. And it may be realized by the configuration that either one or both operation procedures of the connected host control unit 35 and the address allocation unit 382 shown in FIG. 9 and FIG. 10 respectively are stored in memory 40 as a program, and either one or both of the connected host control unit 35 and the address allocation unit 382 are controlled by the CPU 39 based on the program in the CPU 39.

The embedded processor having the program shown in FIG. 9 or FIG. 10, may be installed in the downstream PCI Express Ethernet bridge 3. And either one or both of the connected host control unit 35 and the address allocation unit 382 may be controlled by the program execution of the CPU which is included in the embedded processor.

FIG. 11 is a figure showing the software stack which operates in CPU 11 equipped on the host 1. The software stack includes operating system 61, intermediate I/O device driver 62 which intermediates between a plurality of I/O devices and controls as one I/O devices for operating system 61 and I/O device drivers 63a, 63b which control the individual I/O devices. I/O device driver 63a controls the VF 41a. I/O device driver 63b controls the VF 41b. The intermediate I/O device driver 62 holds the same interface as I/O device drivers 63a and 63b. The intermediate I/O device driver 62 recognizes that the host 1 holds two I/O devices which SR-IOV adaptable I/O 4 provides and the I/O device driver 63a and the I/O device driver 63b are loaded in those. The intermediate I/O device driver 62 uses SR-IOV adaptable I/O 4 by paging the I/O device driver 63a and the I/O device driver 63b.

The intermediate driver can control the I/O device drivers 63a and 63b simultaneously. Accordingly, the intermediate driver can independently control the use or nonuse of the VF 41a and the VF 41b and the respective transmission capacity of the packets which VF 41a and VF 41b uses, respectively. Here, in this exemplary embodiment, the same SR-IOV adaptable I/O are controlled to be connected respectively in a plurality of the different VFs(VF 41a and VF 41b) on the device tree of the host. Accordingly, in the second exemplary embodiment, the intermediate driver can control the I/O packet transfer between the host 1 and the SR-IOV adaptable I/O 4 by VF 41a and VF 41b without changing the address configuration which is indicated in the address conversion table. In other words, the intermediate driver can control the I/O packet transmission of each VF without changing the operation of the address conversion unit.

Next, the operation of the host 1 and the downstream PCI Express-Ethernet bridge 3 when a packet is transmitted from the host 1 for SR-IOV adaptable I/O 4, will be described referring to a drawing.

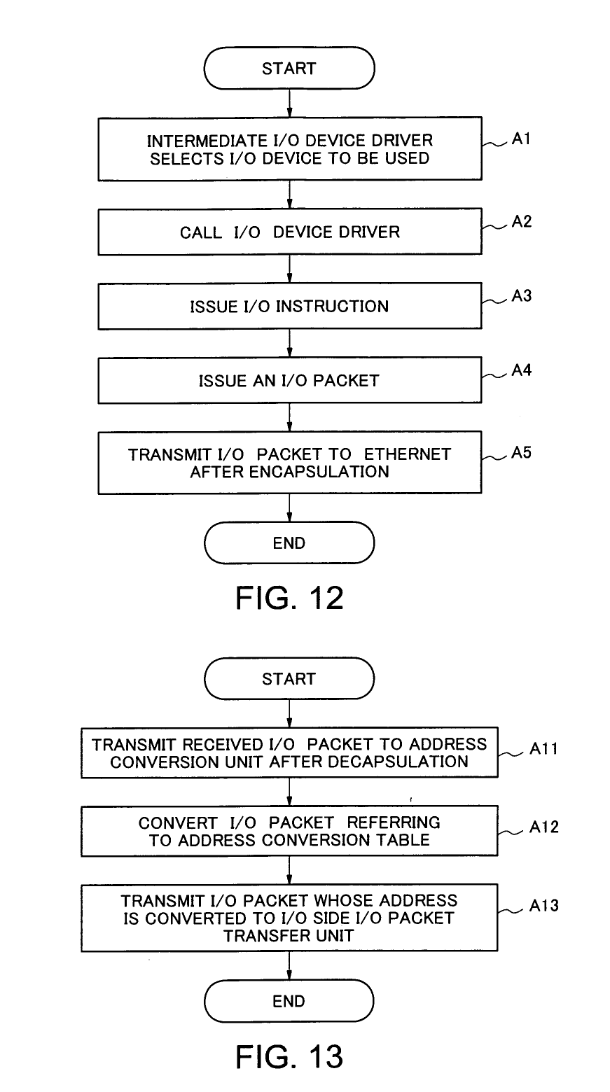

FIG. 12 is a flow chart showing the operation that the software operating in the host 1 issues the I/O packet for SR-IOV adaptable I/O 4. Here, the case that the host 1 issues an I/O packet in the VF 41a will be described.

The intermediate I/O device driver 62 which receives an I/O request from the operating system 61 selects the I/O device to be used (Step A1). Here, for example, it is supposed that I/O device 63a is selected. Next, the intermediate I/O device driver 62 calls I/O device driver 63a (Step A2). When the I/O device driver 63a issues an I/O instruction (Step A3), the bridge 12 issues an I/O packet (Step A4). The upstream PCI Express Ethernet bridge 14a receives the issued I/O packet, encapsulates the MAC address of downstream PCI Express Ethernet bridge 3 in the Ethernet frame as the destination address and transmits it to the Ethernet network 2 (Step A4).

The Ethernet network 2 transports the Ethernet frames which encapsulate the I/O packets (step A5).

FIG. 13 is a flow chart illustrating the operation with which the downstream PCI Express-Ethernet bridge 3 processes the I/O packet that the host has issued.

The Ethernet adapter 31 in the downstream PCI Express-Ethernet bridge 3 receives the Ethernet frame which encapsulates the I/O packet, decapsulates the I/O packet and transmits it to the host side I/O packet transfer unit 32 (Step A11).

The address conversion unit 33 receives the I/O packet from the host side I/O packet transfer unit 32, refers to the address conversion table 37, converts the destination address of the I/O packet from the address which the host 1 has assigned to the VF 41a into the address which the downstream PCI Express Ethernet bridge 3 has assigned to VF 41a and converts the source address of the I/O packet from the host 1 address into the address of the downstream PCI Express Ethernet bridge 3 (Step A12).

The address conversion unit 33 transmits the I/O packet with the converted address to the I/O side I/O packet transfer unit 34 (Step A13).

In this way, the VF 41a receives the I/O packet from the I/O side I/O packet transfer unit 34.

Next, the operation of the downstream PCI Express-Ethernet bridge 3 and the host 1 when the I/O packet is transmitted from the SR-IOV adaptable I/O 4 to the host 1, will be described referring to the drawing.

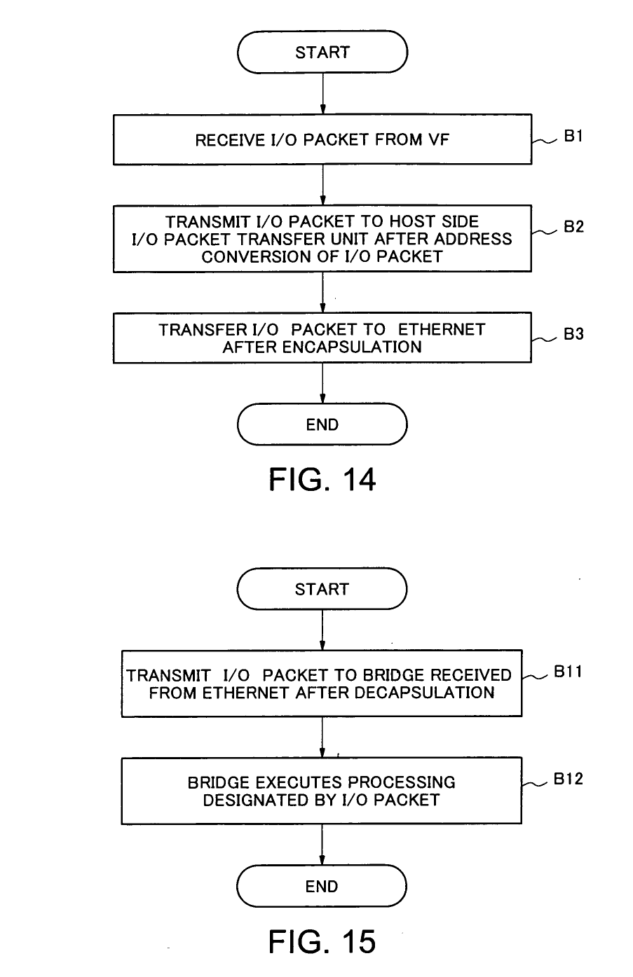

FIG. 14 is a flow chart illustrating the operation with which the downstream PCI Express-Ethernet bridge processes the I/O packet which the SR-IOV adaptable I/O issues. Here, the case is explained that the VF 41a issues the I/O packet to the host 1.

The address conversion unit 33 receives the I/O packet via the I/O side I/O packet transfer unit 34, when the VF 41a issues an I/O packet. (Step B1).

The address conversion unit 33 refers to the address conversion table 37 and converts the destination address of the I/O packet from the address which the downstream PCI Express Ethernet bridge 3 has assigned into the address which the host 1 has assigned. And the address conversion unit 33 converts the source address of the I/O packet from the address which the downstream PCI Express Ethernet bridge 3 has assigned to the VF 41a into the address which the host 1 has assigned to the VF 41a and transmits it to the host side I/O packet transfer unit 32 (Step B2).

The Ethernet adapter 31 receives the I/O packet from the host side I/O packet transfer unit and encapsulates the I/O packet to the Ethernet frame using MAC address in the upstream PCI Express Ethernet bridge 14a. The Ethernet adapter 31 transmits the encapsulated I/O packet to the Ethernet network 2 (Step B3).

FIG. 15 is a flow chart illustrating the operation with which the host processes the I/O packet that the SR-IOV adaptable I/O 4 has issued.

In FIG. 15, the upstream PCI Express Ethernet bridge 14 receives the Ethernet frame which encapsulates the I/O packet, decapsulates the I/O packet and transmits it to bridge 12 (Step B11). And the bridge 12 receives the I/O packet and performs the processing designated by the I/O packet such as interruption to the CPU 11 and the DMA processing to the memory 13 (Step B12).

Further, the procedure described in FIGS. 12 to 15 may be realized by using a computer program.

As described above, a plurality of communication routes between the host and the SR-IOV adaptable I/O can be flexibly controlled in the network system in which the PCI Express I/O packet encapsulated in the Ethernet is sent and received between the host and the SR-IOV adaptable I/O, according to this embodiment.

The reason is because the same SR-IOV adaptable I/O is controlled so as to be connected to the different busses respectively in the device tree of the host by allocating the plural different VFs to the same SR-IOV adaptable I/O. And it is because the intermediate driver can control the plural VFs connected to the same SR-IOV adaptable I/O without changing the VF configuration, by controlling the VF in this way.

As the first modification of the second exemplary embodiment, the intermediate I/O device driver 62 may operate one of two I/O devices as working system and the other as standby system. In this case, the intermediate I/O device driver 62 may switch the standby I/O to the working system when failures occur in the upstream PCI Express-Ethernet bridge corresponding to the working I/O device or in the cables and the buses which the bridge connects.

For example, it is supposed in FIG. 1 that the system which the host 1 and the VF 41a are connected via the upstream PCI Express-Ethernet bridge 14a is the working system while the system which the host 1 and the VF 41b are connected via upstream PCI Express-Ethernet bridge 14b is the standby system. In this case, the intermediate I/O device driver 62 can control so that the transmission route of the packet may be switched to the VF 41b when failures occur on the route of the VF 41a which is used as the working system. From the view point of the intermediate driver 62, the VF 41a and the VF 41b are controlled to be connected to the same kind of individual SR-IOV adaptable I/Os. For this reason, it is not needed to start the hardware in the host 1, the downstream PCI Express-Ethernet bridge 3 and the SR-IOV adaptable I/O 4 when the route is switched from the VF 41a to the VF, 41b. Furthermore, the processing is not needed such as changing the destination address of the VF connection or rewriting the address conversion table.

As a result, the effect that the packet transmission system can be switched to the redundant system rapidly is provided in the first modification in addition to the effect described in the second exemplary embodiment.

As another second modification of the second exemplary embodiment, the intermediate I/O device driver 62 may operate both of two I/O devices as working system simultaneously. In this case, it is possible that the I/O instructions are set in load balancing state between plural I/O devices by the function of intermediate I/O device driver 62.

For example, in FIG. 1, the intermediate I/O device driver 62 may use the route connecting to the VF 41a via the upstream PCI Express-Ethernet bridge 14a from the host 1 and the route connecting to VF 41b via the upstream PCI Express-Ethernet bridge 14b from the host 1, simultaneously. And the transmission capacity assigned to respective VFs may be changed and the load balancing may be performed depending on the situation of the transmission line.

Similar to the first modification, the VF 41a and the VF 41b whose routes are different are controlled so as to be connected to the same kind of individual SR-IOV adaptable I/Os, from the view point of the intermediate driver 62. Therefore, no restart of the hardware is needed in the host 1, the downstream PCI Express-Ethernet bridge 3 and the SR-IOV adaptable I/O 4 even in the load balancing state between the VF 41a and the VF 41b. Furthermore, the processing is not needed such as changing the destination address of the VF connection or rewriting the address conversion table.

The data transfer capability for the SR-IOV adaptable I/O 4 can be also maintained for the case that the data transfer capacity of a certain upstream PCI Express-Ethernet bridge declines in the configuration which employs a plurality of I/O devices as working system simultaneously. This can be realized by increasing the data transfer capacity of the route which uses the I/O device corresponding to the residual upstream PCI Express-Ethernet bridge.

As a result, the second modification of the second embodiment provides the effect that the load balancing among a plurality of VFs is easily performed in addition to the effect described in the second embodiment.

Further, the second embodiment has been shown to consist of one host 1 and one SR-IOV adaptable I/O 4. However, the applicable embodiment structure of the present invention is not limited to this. For example, the configuration of a plurality of hosts and one SR-IOV adaptable I/O 4 is also possible. In this case, when a plurality of hosts are hosts 1a and 2a, the VF 41a and the VF 41b may be assigned to the host 1 a and assign different VFs, VF 41c and VF 41d to the host 1b.

The configuration that a plurality of SR-IOV adaptable I/Os 4 are connected to one host 1 is also possible. In this case, each SR-IOV adaptable I/O 4 is connected to the Ethernet 2 via individual downstream PCI Express Ethernet bridge 3 respectively. The upstream PCI Express Ethernet bridge 14a and the upstream PCI Express Ethernet bridge 14b are connected to the downstream PCI Express Ethernet bridge 3 corresponding to SR-IOV adaptable I/O 4 in a manner of one to one. And each upstream PCI Express Ethernet bridge provides a route of the I/O bus to either one of different VFs which each SR-IOV adaptable I/O includes.

The system including multiple hosts 1 and multiple SR-IOV adaptable I/Os 4 can be realized by the combination of the case mentioned above that only host 1 is multiple and the case that only SR-IOV adaptable I/O 4 is multiple.

In the second embodiment, the configuration and operation have been described using the configuration that connects two upstream PCI Express Ethernet bridges to host 1. However, the number of the upstream PCI Express Ethernet bridges is not limited, provided it is no smaller than two. In this case, the VF corresponding to the number of the upstream PCI Express Ethernet bridges connected to the host is assigned to host 1 from SR-IOV adaptable I/O 4. In this way, the number of VF is not limited to two.

As the second exemplary embodiment, the PCI Express has been explained as an example of I/O bus and the Ethernet network has been explained as the network means which connects a host and I/O. However, the kind of I/O buses and network means is not limited to these. The present invention can also be applied to the configuration using these I/O buses and other protocols which provide the similar function to these I/O buses and network means.

According to the present invention, the network apparatus, the network configuration method and the program recording medium in which the program of the network apparatus is recorded controls a plurality of I/O buses connected to peripheral devices from the host to be connected to different interfaces respectively.

As a result, the present invention provides the effect that it can compose the I/O bus flexibly which connects the host and the peripheral device.

Although the present invention has been described with reference to the exemplary embodiments and the modifications, the present invention is not limited to the above-mentioned exemplary embodiments. The configuration and detail of the present invention can be modified within the scope of the present invention into various ways which those skilled in the art can understand.

1. A network apparatus, comprising:
a first interface unit which connects a host which holds a plurality of I/O buses and said network apparatus via a network;
a second interface unit which connects a peripheral device which holds a plurality of I/O interfaces and said network apparatus; and
a control unit which controls the plurality of I/O interfaces to be connected to branches of different said I/O buses respectively.

2. The network apparatus according to claim 1, wherein said control unit includes:
a connection virtualization unit which has an address allocation unit for which said network apparatus assigns a first address to said I/O interface and an address corresponding unit which correlates a second address which said host assigns to said I/O interface with said first address;
an address holding unit which holds said first address and said second address that said address corresponding means correlates; and
an address converting unit which converts an address indicated in an I/O packet that is transferred via said first interface unit and second interface unit between said host and said peripheral device referring to said address holding unit.

3. The network apparatus according to claim 2, wherein
said address allocation unit collects information of said peripheral device, assigns the address which said peripheral device requests to said I/O interface based on said information, and registers the assigned address to said address holding unit.

4. The network apparatus according to claim 2, further comprising:
a network adaptor unit which encapsulates said I/O packet by a predetermined network unit, correlates the plurality of network interfaces of said host with each said I/O interface, sends and receives said encapsulated I/O packet between said network interfaces.

5. The network apparatus according to claim 4, further comprising:
a connected host control unit which informs said network adaptor unit of identification information of said network interface, assigns said I/O interface corresponding to said network interface for the route in which said I/O packet is sent and received.

6. The network apparatus according to claim 1,
wherein
the network that said network apparatus connects is compliant with the Ethernet (®),
said I/O bus is compliant with the PCI Express,
and said peripheral device is compliant with the SR-IOV.

7. The network apparatus according to claim 1,
wherein
said host includes an intermediate device driver that mediates device drivers loaded individually to said I/O interface, uses an interface which at least one of said device drivers controls as working system and uses the other interface which at least one of said device drivers controls as standby system.

8. The network apparatus according to claim 1,
wherein
said host includes an intermediate device driver that mediates device drivers loaded individually to said I/O interface and performs load balancing control of I/O instructions between at least two interfaces that said device driver controls.

9. A network system comprising:
a host that holds a plurality of I/O buses;
a peripheral device that includes a plurality of I/O interfaces; and
a network apparatus that includes a first interface unit which connects said host and said apparatus via a network, a second interface unit which connects said peripheral device and said apparatus and a control unit which controls the plurality of I/O interfaces to be connected to branches of different said I/O buses respectively.

10. A network configuration method comprising:
connecting a host which includes a plurality of I/O buses and said network apparatus via a network;
connecting a peripheral device which includes a plurality of I/O interfaces and said network apparatus; and controlling the plurality of I/O interfaces to be connected to branches of different said I/O buses respectively.

11. A program recording medium which records a network apparatus program tangibly in order to perform the function as
a first interface unit which connects a host including a plurality of I/O buses and a network apparatus via a network;
a second interface unit which connects a peripheral device including a plurality of I/O interfaces and said network apparatus; and
a control unit which controls the plurality of I/O interfaces to be connected to branches of different said I/O buses respectively.

12. A network means, comprising:
first interface means for connecting a host which holds a plurality of I/O buses and said network means via a network;
second interface means for connecting a peripheral device which holds a plurality of I/O interfaces and said network means; and
control means for controlling the plurality of I/O interfaces to be connected to branches of different said I/O buses respectively.

13. A network system comprising:
host means for holding a plurality of I/O buses;
peripheral device means for including a plurality of I/O interfaces; and
network means that includes first interface means for connecting said host and said network means via a network, second interface means for connecting said peripheral device and said network means and control means for controlling the plurality of I/O interfaces to be connected to branches of different said I/O buses respectively.
